(19) United States
(12) Patent Application Publication
(10) Pub. No.: US 2014/0184787 A1
(43) Pub. Date: Jul. 3, 2014

(54) DEVICE FOR DETERMINING SURFACE DEFECTS

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/101,350

(22) Filed: Dec. 10, 2013

(30) Foreign Application Priority Data
Dec. 28, 2012 (TW) 101150749

(51) Int. Cl. G06T 7/00

(52) U.S. Cl. CPC G06T 7/0004; G06T 7/001
USPC 348/128

(57) ABSTRACT

A device is used for determining whether or not a product has any surface defects. The device includes a platform, a mirror, an image capturing unit, and a processing unit. The mirror and the image capturing unit are respectively adjacent to a first side and second side of the platform. The mirror forms an image of a product on the platform. The image capturing unit simultaneously captures both an image of the actual product placed on the platform and an image of the image of the product in the mirror. The captured images of the product are analyzed and matched against similar views of a blemish-free model product, any discrepancies leading to a determination that the product has any surface defects.

### BACKGROUND

1. Technical Field

The present disclosure relates to a device for determining whether or not a product has surface defects.

2. Description of Related Art

In manufacturing, due to the need for high quality and efficient production, monitoring systems are required for checking products after they are manufactured. For example, there is a need to determine whether or not a product has any surface defects, such as scratching or smudging. When a typical monitoring system is used to detect surface defects, an image capturing unit is employed to move in different directions and capture images of the product showing various aspects of the product. However, moving the image capturing unit in different directions to capture the images is somewhat time-consuming and cumbersome. That is, the efficiency of the process is rather low.

Therefore, what is needed is a device to solve the problems described above.

### BRIEF DESCRIPTION OF THE DRAWINGS

Many aspects of the present disclosure should be better understood with reference to the following drawings. The components in the drawing(s) are not necessarily drawn to scale, the emphasis instead being placed upon clearly illustrating the principles of the present device. Moreover, in the drawings, like reference numerals designate corresponding components throughout the views.

FIG. 1 is an isometric view of a device for determining surface defects, in accordance with an exemplary embodiment.

FIG. 2 is a schematic block diagram of an external computing device and an image capturing unit of the device of FIG. 1.

### DETAILED DESCRIPTION

Embodiments of the present disclosure are described with reference to the accompanying drawings.

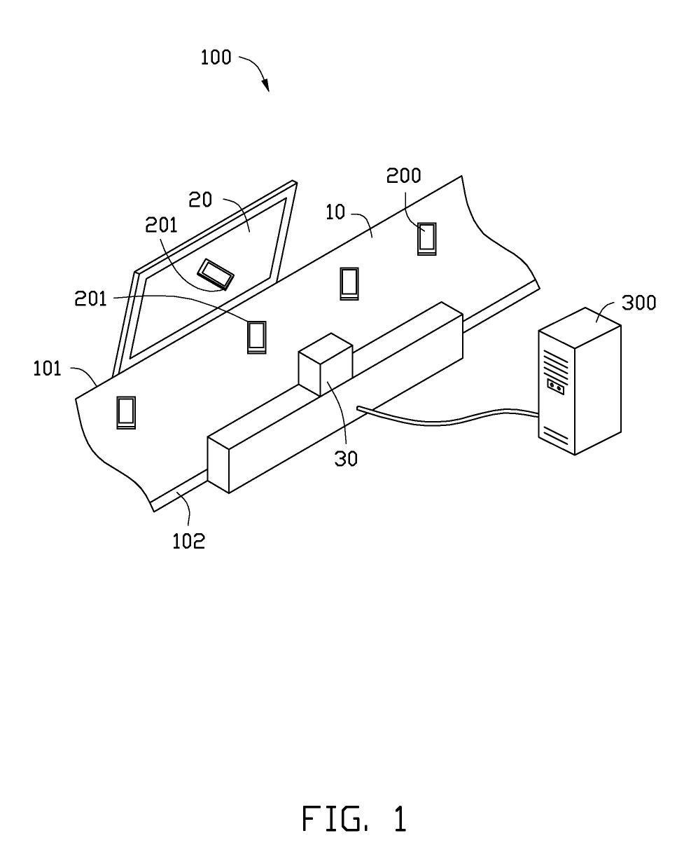

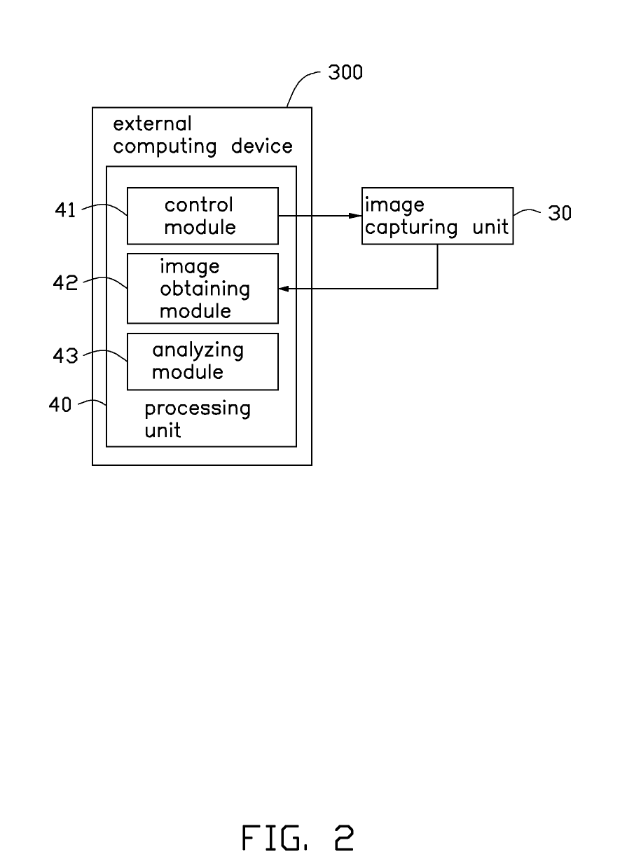

FIGS. 1-2 show an exemplary embodiment of a device 100 for determining whether or not a product 200 has any surface defects (e.g., scratching or other non-uniformity). The device 100 includes a platform 10, a mirror 20, an image capturing unit 30, and a processing unit 40.

The platform 10 is used to support the product 200. In this embodiment, the platform 10 is a conveyer. The platform 10 includes a first side 101 and a second side 102 opposite to the first side 101.

The mirror 20 is connected to one of the first side 101 and the second side 102, and is oriented at a certain angle, such as eighty degrees. Thus the mirror 20 forms an image of the product 200 placed on the platform 10. In this embodiment, the product 200 is rectangular, and a first corner 201 of the rectangular product 200 faces the mirror 20. Thus a top surface and two sidewalls of the product 200 connected to the first corner 201 are shown in the mirror 20.

The image capturing unit 30 is arranged on the other one of the first side 101 and the second side 102, and faces the mirror 20. In this embodiment, the image capturing unit 30 is a camera. The image capturing unit 30 simultaneously captures both an image of the actual product 200 placed on the platform and an image of the image of the product 200 in the mirror 20. Thus, the one pair of captured images includes views of all four sidewalls and the top surface of the product 200. Accordingly, unlike in conventional art, the image capturing unit 30 does not need to move or rotate in different directions to capture images of the product 200.

In this embodiment, the angle of the image capturing unit 30 can be adjusted by an operator (e.g. a human user) as needed.

Referring to FIG. 2, the processing unit 40 includes a control module 41, an image obtaining module 42, and an analyzing module 43, which are individually and in combination a collection of instructions that are executed by the processing unit 40. In this embodiment, the processing unit 40 is arranged in an external computing device 300. The processing unit 40 communicates with the image capturing unit 30 via a wireless or wired access interface. In other embodiments, the processing unit 40 may be arranged in the platform 10 or the image capturing unit 30.

The control module 41 communicates with the image capturing unit 30, and controls the image capturing unit 30 to capture images of the product 200 according to preset parameters stored in the computing device 300. In this embodiment, the stored parameters include the time interval between each two times that the image capturing unit 30 captures images. In the present embodiment, the stored parameters are preset by a user via a peripheral input device (not shown), such as a keyboard, of the computing device 300.

The image obtaining module 42 obtains the captured images of the product 200.

The analyzing module 43 determines whether or not the product 200 has any surface defects according to the obtained images. In the embodiment, the analyzing module 43 compares the obtained images of the product 200 with stored images of a standard product.

If the obtained images of the product 200 match the stored images of the standard product, the analyzing module 43 determines that the product 200 has no surface defect. If there is any discrepancy between the obtained images and the stored images, the analyzing module 43 determines that the product 200 has one or more surface defects. In an alternative embodiment, the analyzing module 43 may employ a Fourier transform to the obtained images to generate a number of frequency spectrograms, and determine whether or not the product 200 has a surface defect according to the generated frequency spectrograms. The technology of determining surface defects on a product according to frequency spectrograms is known in the art. See for example the subject matter of U.S. Pat. No. 7,069,154, which is incorporated herein by reference.

In the embodiment, the control module 41 outputs the result of the determination by the analyzing module 43 to the computing device 300. Specifically, the result output by the analyzing module 43 can be an audio file or a text message.

Although the present disclosure has been specifically described on the basis of exemplary embodiments thereof, the disclosure is not to be construed as being limited thereto. Various changes or modifications may be made to the embodiments without departing from the scope and spirit of the disclosure.

What is claimed is:

1. A device for determining whether or not a product has surface defects, the device comprising:
a platform to support the product, the platform comprising a first side and a second side opposite to the first side;
a mirror adjacent to one of the first side and the second side to form an image of the product on the platform;
an image capturing unit adjacent to the other one of the first side and the second side, and facing the mirror, wherein the image capturing unit is configured to simultaneously capture an image of the product on the platform and an image of the image of the product in the mirror; and
a processing unit comprising:
a control module to control the image capturing unit to capture the image of the product on the platform and the image of the image of the product in the mirror;
an image obtaining module to obtain the captured images; and
an analyzing module to determine whether or not the product has any surface defects according to the obtained images.

2. The device as described in claim 1, wherein the platform comprises a conveyer.

3. The device as described in claim 1, wherein the processing unit is arranged in an external computing device, and the processing unit communicates with the image capturing unit via one of a wireless access interface and a wired access interface.

4. The device as described in claim 1, wherein the control module controls the image capturing unit to capture images of the product according to preset parameters, and the preset parameters comprise a time interval between each two times that the image capturing unit captures images.

5. The device as described in claim 1, wherein the analyzing module compares the obtained images of a product with stored images of a standard product; and if the obtained images of the product match the stored images of the standard product, the analyzing module determines that the product has no surface defect; and if there is any discrepancy between the obtained images and the stored images, the analyzing module determines that the product has one or more surface defects.

6. The device as described in claim 1, wherein the analyzing module employs a Fourier transform to the obtained images to generate a plurality of frequency spectrograms, and determines whether or not the product has a surface defect according to the generated frequency spectrograms.
